(19) United States
(12) Patent Application Publication
(10) Pub. No.: US 2025/0140453 A1
(43) Pub. Date: May 1, 2025

(54) ELECTRICAL RESISTANCE COMPONENT

(71) Applicant: VISHAY ELECTRONIC GMBH, Selb (DE)

(72) Inventors: Thomas Asperger, Selb (DE); Sven Huttner, Heilbromm (DE); Jong Huttner, Hof (DE)

(73) Assignee: VISHAY ELECTRONIC GMBH, Selb (DE)

(21) Appl. No.: 18/683,105

(22) PCT Filed: Aug. 1, 2022
(86) PCT No.: PCT/EP2022/071501

§ 371 Date: Feb. 12, 2024

(30) Foreign Application Priority Data
Aug. 16, 2021 (DE) 10 2021 121 240.5

(51) Int. Cl. H01C 7/18; H01C 1/14; H01C 17/28

(52) U.S. Cl. CPC H01C 7/18; H01C 1/14; H01C 17/28

(57) ABSTRACT

An electrical resistance component comprises an electrically insulating carrier, at least one resistance layer on the carrier, and at least one electrical connector formed at the carrier and connected to the resistance layer, wherein the resistance layer has a surface structure along its surface at a side facing away from the carrier. The resistance layer is further covered by a barrier layer that comprises an inorganic material and that reproduces the surface structure of the resistance layer continuously and with a uniform thickness.

### CROSS-REFERENCE TO RELATED APPLICATIONS

This application is the U.S. National Phase of PCT Appln. No. PCT/EP2022/071501, filed Aug. 1, 2022, which claims the benefit of German Patent Appln. No. 102021121240.5, filed Aug. 16, 2021, the entire disclosures of which are incorporated by reference herein.

### TECHNICAL FIELD

The invention relates to an electrical resistance component comprising an electrically insulating carrier; at least one resistance layer on the carrier; and at least one electrical connector formed at the carrier and connected to the resistance layer. The resistance layer further has a surface structure along its surface at a side facing away from the carrier and is covered by a barrier layer.

### BACKGROUND

Such electrical resistance components may be used in numerous applications in order, for example, to be able to intentionally limit a current flow between two further electrical components of an electrical circuit. Furthermore, such electrical resistance components are frequently used in microchips so that an increasing reduction in the size of the components is aimed for, wherein in particular a flat or a thin design of the components used may be required. At the same time, however, a high accuracy is usually required for electrical resistance components such that, for example, a narrow tolerance range between 1% and 0.01% may be predefined. Furthermore, a low temperature coefficient between 1 ppm/K and 50 ppm/K may be required for a resistance component to ensure a reliable use of the electrical resistance component under load. Furthermore, the desired long-term stability of electrical resistance components requires protection with respect to environmental influences, wherein, for example, requirements of a maximum change of 0.1% to 0.5% after 1000 hours of load at approximately 10% nominal load, 85% air humidity, and 85° C. may be satisfied.

However, the problem in particular arises with small and/or flat electrical resistance components that the resistance layer, due to its relatively small layer thickness, may have a high sensitivity with respect to corrosion, in particular by anodic oxidation, on a simultaneous application of an electrical voltage. This problem may generally be countered in that the resistance layer is covered by a barrier layer at a side facing away from the carrier in order to protect the resistance layer against the influence of moisture. However, the application of such a barrier layer requires gentle and therefore frequently complex processes since the resistance layer may not be altered or damaged by the process of the application in order not to change a previously precisely set characteristic of the electrical resistance component, in particular a resistance value, by the application of the barrier layer.

For example, one or more layers of an organic compound, for example an epoxy resin or a silicone resin, may be used as the barrier layer. However, sufficient protection with respect to moisture in vapor form may usually not be achieved by organic materials, said moisture being able to come into contact with the resistance layer through an organic barrier layer such that organic barrier layers may only provide incomplete protection of the resistance layer.

Alternatively thereto, barrier layers for electrical resistance components may also be formed by inorganic materials to increase the protective effect with respect to vaporous moisture. For this purpose, the barrier layer may, for example, be applied to the resistance layer by a sputtering process, for which purpose specific materials are, however, usually required whose manufacture is relatively complex and/or expensive. Furthermore, such inorganic barrier layers may only form a hermetic sealing of the resistance layer at a relatively high layer thickness and the surface of the resistance layer may in particular be covered in a non-conform manner by a sputtering process such that depressions with respect to the barrier layer or microscopic hollow spaces between the resistance layer and the barrier layer may remain due to the surface structure of the resistance layer. To cover these hollow spaces, the already mentioned undesirably large layer thickness of the barrier layer is required, on the one hand, while the hollow spaces may furthermore generally also impair the sought after protective effect of the resistance layer by the barrier layer.

### SUMMARY

It is an object of the invention to provide an electrical resistance component that may be flat or thin and that has a high stability with respect to environmental influences and in particular moisture influences.

This object is satisfied by an electrical resistance component having the features of claim 1 and in particular in that the barrier layer comprises an inorganic material, and in that the barrier layer reproduces the surface structure of the resistance layer continuously and with a uniform thickness.

Due to the covering of the resistance layer by a continuous barrier layer of uniform thickness that reproduces the surface structure of the resistance layer along its surface, a conform covering of the resistance layer may in particular be achieved. In this respect, every position of the surface of the resistance layer at the side of the resistance layer facing away from the carrier may be directly in contact with the barrier layer. However, a continuously direct contact of the barrier layer with the resistance layer or with a current-conducting layer of the resistance layer is not absolutely necessary; rather, it is important that the barrier layer forms a continuous barrier above the resistance layer.

The reproduction of the surface structure of the resistance layer along its surface means that not, for instance, only the course of the transitions between the carrier and the resistance layer is reproduced (for example, a step-like transition between the absence and the presence of the resistance layer on the carrier); rather, the surface structure in those regions in which the resistance layer is present at all is reproduced by the barrier layer with a uniform thickness. Gaps of the barrier layer may thereby in particular be avoided such that a reliable hermetic sealing of the resistance layer may already be achieved at a small layer thickness. Due to the continuous covering and reproduction of the resistance layer, the resistance layer is not only sectionally covered by the barrier layer, but is in particular covered over the total surface by the barrier layer in order to seal the total surface of the resistance layer against a penetration of moisture.

The electrical resistance component may, for example, be configured as a thin-film resistance component (also designated as a thin-layer resistance component). In such resistance components, the resistance layer may, for example, be applied to the carrier by a sputtering process such that the resistance layer may form a thin film, in particular a thin metal film, on the carrier. The resistance layer of a thin-film resistance component may furthermore have a layer thickness that is less than a roughness of a surface of the carrier. For example, a resistance layer of an electrical resistance component configured as a thin-film resistance component may have a layer thickness in a range of 50 nanometers (nm) to 500 nanometers (nm). In contrast, a carrier typically used for such electrical resistance components may, for example, have a surface having a roughness of 1 micrometer (μm) to 3 micrometers (μm) such that the surface structure of the resistance layer at the side facing away from the carrier may in particular mainly be determined by the roughness of the surface of the carrier.

A roughness of the surface structure of the resistance layer and/or of another surface mentioned in connection with the invention may in particular be determined by the fifth or sixth order of the shape deviation in accordance with DIN 4760.

Alternatively to a configuration as a thin-film resistance component, the electrical resistance component may, for example, also be configured as a thick-film resistance component. In the case of such electrical resistance components, the resistance layer may in particular be applied or burned in onto the carrier in the form of a paste, for example a glass paste, in which metal particles or metal oxide particles are included, wherein in particular an application by means of screen printing may be provided. Such resistance layers may have a layer thickness of up to approximately 10 μm such that, in the case of an electrical resistance component configured as a thick-film resistance component, the layer thickness of the resistance layer may exceed a roughness of the surface of the carrier that may again be in a range of 1 μm to 3 μm. However, in such an electrical resistance component, the resistance layer may itself have a roughness that may ultimately determine the surface structure of the resistance layer at the side facing away from the carrier. For example, a roughness of a surface of a resistance layer formed as a thick-film resistance layer may also be in a range of approximately 0.1 μm to 3 μm.

A resistance value of an electrical resistance component, which is configured as a thick-film resistance component, may in particular be determined by the density of the metal particles or of the metal oxide particles in the paste that is applied as a thick-film resistance layer to the carrier. However, provision may additionally be made to provide such a resistance layer with a trimming structure, for example after the application of the resistance layer to the carrier by a lithographic treatment or a treatment by means of a laser beam, to define a precise resistance value of the electrical resistance component. In contrast, in the case of an electrical resistance component configured as a thin-film resistance component, the resistance layer may, as already explained, first form a thin and closed metal film that may, however, be provided with a trimming structure to precisely set the desired resistance value.

Irrespective of a configuration of the electrical resistance component as a thin-film resistance component or as a thick-film resistance component, the resistance layer may furthermore comprise electrically conductive materials and, if applicable, electrically non-conductive materials. Moreover, the resistance layer may comprise a current-conducting layer on which—as part of the resistance layer—an additional, but non-conform and in particular electrically non-conducting material layer may in particular be sectionally applied. For example, such an additional material layer of the resistance layer may serve to stabilize the current-conducting part of the resistance layer. Such a material layer may in particular comprise an inorganic material and may, for example, be applied by sputtering to a current-conducting layer of the resistance layer such that the material layer may in particular collect at points of the surface of the current-conducting layer that are elevated with respect to the carrier, while depressions may be covered by a material layer of a smaller thickness or may remain uncovered by the material layer. Such an additional material layer of the resistance layer may, at the sections at which the additional material layer is present at all, have a thickness that is considerably less than the thickness of the current-conducting layer of the resistance layer and/or that is approximately equal to or less than the thickness of the barrier layer.

In this regard, such a material layer of the resistance layer—that is an additional material layer with respect to a current-conducting layer actually defining the resistance value of the electrical resistance component—may possibly at least partly influence the surface structure of the resistance layer at a side facing away from the carrier. Accordingly, in such resistance layers, the barrier layer, which reproduces the surface structure of the resistance layer, may sectionally contact the current-conducting layer and sectionally contact the additional material layer. If applicable, on a complete covering of a current-conducting layer by an additional, but non-conform material layer, the barrier layer may also only be in contact with the additional material layer and not with a current-conducting layer of the resistance layer. However, such a material layer as part of the resistance layer in particular differs from the barrier layer in that the additional material layer does not cover the current-conducting layer of the resistance layer in a conform manner, i.e. does not cover it with a uniform thickness, and/or does not continuously cover said current-conducting layer. However, such an additional material layer is not absolutely necessary; rather, the resistance layer may also be formed by a current-conducting layer that is directly covered by the barrier layer.

Since the resistance layer has the surface structure along its surface, the surface structure may in particular determine a microscopic roughness of the surface of the resistance layer. For example, the resistance layer, in particular of a thin-film resistance component, may be applied to the insulating carrier by physical vapor deposition, for instance a sputtering process. Such a resistance layer may have a thickness of 50 nanometers to 500 nanometers, while a roughness of the surface of the carrier may, however, be in a range of approximately 0.1 μm to 3 μm. In this regard, the roughness of the surface of the resistance layer in a thin-film resistance component may be substantially determined by the roughness of the surface of the carrier such that the surface structure of the resistance layer may mainly follow the roughness of the carrier. In the case of an electrical resistance component configured as a thick-film resistance component, the thickness of the resistance layer may, in contrast, exceed a roughness of the surface of the carrier such that, in such resistance components, the surface structure of the resistance layer at the side facing away from the carrier may not be determined by the already compensated roughness of the surface of the carrier, but rather by the roughness of the surface of the resistance layer itself. This roughness may also be in a range of approximately 0.1 μm to 3 μm due to the application of such thick-film resistance layers, for example, by means of screen printing.

In particular in a configuration of the electrical resistance component as a thin-film resistance component, the resistance layer may further have gaps that may be produced by a shadowing effect on the application of the resistance to the carrier. For example, such a resistance layer may be applied to the carrier by a directed process, for instance, a sputtering process. The carrier may have an overshadowed section that may be covered by a further section of the carrier and may lie in its “shadow” with respect to a direction along which the resistance layer is applied. In such cases, the material used to form the resistance layer may possibly not reach, or not completely reach, the overshadowed section such that the surface of the carrier in the overshadowed section is not covered by the resistance layer, but the resistance layer has a gap or a “pinhole”. Since the barrier layer is continuously applied and reproduces the surface structure of the resistance layer with a constant thickness, such gaps of the resistance layer, i.e. the carrier exposed in the region of the gap, may also be uniformly covered by the barrier layer, wherein the barrier layer is “pinhole-free” or formed without gaps. Any edges of such gaps of the resistance layer may thereby also be covered by the barrier layer such that the edges may likewise be protected from a contact with moisture. In the gaps of the resistance layer, the barrier layer may in particular be directly applied to the surface of the carrier.

The barrier layer may follow the surface structure of the resistance layer such that the roughness of the surface of the resistance layer may determine the roughness at a surface of the barrier layer at a side facing away from the resistance layer. The surface structure is thus in particular a structure at the surface of the resistance layer itself and not larger structures or interruptions of the resistance layer that may, in particular in the case of an electrical resistance component configured as a thick-film resistance component, for example, be formed by a lithographic treatment or a treatment by means of a laser beam after the application of the resistance layer to the carrier in order, for example, to trim a resistance layer to a specific resistance value.

The thickness of the barrier layer may correspond to a spacing between the surface of the barrier layer at a side facing away from the resistance layer and the surface of the resistance layer at the side facing away from the carrier, wherein this spacing may be determined at a respective position of the surface of the resistance layer, in particular along a normal of a tangent that describes the curvature of the surface structure of the resistance layer at the respective position of the surface of the resistance layer. The “thickness” of the barrier layer may thus in particular in inclined courses differ from a “height” of the barrier layer and the barrier layer may also have a surface structure at a side facing away from the resistance layer and may not be planar. The surface structure of the resistance layer is thus not compensated or covered by the barrier layer, but is substantially reproduced.

Since the barrier layer reproduces the surface structure of the resistance layer with a uniform thickness, a surface structure of the barrier layer may follow the surface structure of the resistance layer along its surface at a side facing away from the resistance layer. A three-dimensional course of the surface structure of the barrier layer at the side facing away from the resistance layer may therefore substantially reflect the three-dimensional course of the surface structure of the resistance layer at the side facing away from the carrier, wherein a spacing between the surface of the resistance layer at the side facing away from the carrier and the surface of the barrier layer at the side facing away from the resistance layer along a respective normal of the surface of the resistance layer may always correspond to the thickness of the barrier layer. Conversely, a surface structure of the barrier layer at a side facing the resistance layer may so-to-say form a relief of the surface structure of the resistance layer at the side facing away from the carrier. A three-dimensional course of the surface structure of the resistance layer along its surface at the side facing away from the carrier and a three-dimensional course of the surface structure of the barrier layer at a side facing the resistance layer may thus in particular correspond to one another such that the surface of the resistance layer at the side facing away from the carrier may be directly in contact with the barrier layer at every position.

Due to the reproduction of the surface structure of the resistance layer and in particular to a sufficiently small thickness of the barrier layer, a surface structure of the barrier layer at a side facing away from the resistance layer may also substantially correspond to the surface structure of the resistance layer, apart from displacements or homogenizations due to the thickness of the barrier layer. A surface of the barrier layer may in particular be displaced by the thickness of the barrier layer with respect to the surface of the resistance layer such that, for example, a depression of the surface structure of the resistance layer, which may have a specific width or a specific spacing between mutually opposite boundaries, may be reproduced as a depression in the surface structure of the barrier layer at the side facing away from the resistance layer, the width of said depression, for example, being reduced by approximately twice the thickness of the barrier layer with respect to the width of the depression in the surface structure of the resistance layer. In contrast, due to the uniform covering of the resistance layer, respective depths of such depressions in the surface structure of the resistance layer at the side facing away from the carrier and in the surface structure of the barrier layer at the side facing away from the resistance layer may correspond to one another.

The roughness of the surface structure of the barrier layer at its side facing away from the resistance layer may therefore be similar to the roughness of the surface structure of the resistance layer, wherein the roughness of the surface structure of the barrier layer may, however, be somewhat less than the roughness of the surface structure of the resistance layer due to a certain homogenization of the covered surface structure of the resistance layer.

Despite the thin layer thickness, such a reproduction of the surface structure of the resistance layer in particular enables a tight seal between the resistance layer and the barrier layer to reliably protect the resistance layer against corrosion and changes in the electrical characteristics of the electrical resistance component, for instance of an electrical resistor, that are thereby brought about. Microscopic depressions and hollow spaces in the surface structure of the resistance layer or gaps in the resistance layer may in particular also be precisely covered or lined, and not for instance only covered, by the barrier layer such that a remaining of such hollow spaces between the resistance layer and the barrier layer may be avoided. The barrier layer may cover the surface of the resistance layer completely and “pinhole-free”, in particular also on the presence of such hollow spaces or gaps in the surface of the resistance layer.

However, it is also possible in the case of a barrier layer reproducing the surface structure of the resistance layer that a depression or a hollow space in the surface structure of the resistance layer has a width that is less than twice the thickness of the barrier layer such that such microscopic depressions and/or hollow spaces may, if necessary, be completely filled and closed by the barrier layer. In the region of such filled hollow spaces, but in particular only in the region of such filled hollow spaces, the thickness of the barrier layer may, starting from one side of the depression or of the hollow space in the direction of the other side of the depression of the hollow space, thus possibly also correspond to the spacing of the two sides of the depression or of the hollow space from one another. Furthermore, in such narrow hollow spaces or depressions, the thickness of the barrier layer, viewed from a lowest point of the depression or of the hollow space, may possibly correspond to the depth of the depression or of the hollow space. A covering of the total resistance layer by a barrier layer of a uniform thickness is, however, ultimately also present here since these deviations are not determined by the barrier layer itself, but result from the specific structure of the surface of the resistance layer in such a region.

Due to the design of the barrier layer with an inorganic material, the resistance layer may be reliably protected with respect to an influence by moisture in vapor form that may penetrate conventional organic barrier layers. Such a conform barrier layer having an inorganic material may, as initially explained, indeed not be achieved by the sputtering which is typical for electrical resistance components and during which hollow spaces between the resistance layer and the barrier layer remain, but an application of a conform inorganic barrier layer by atomic layer deposition is possible, for example.

In such a method of applying the barrier layer by atomic layer deposition, the resistance layer may, for example, first be covered by means of chemical vapor deposition in a reaction chamber by a first reactant that reacts in a self-limiting manner with the surface of the resistance layer. The self-limiting reaction makes it possible to cover the surface of the resistance layer with at most one atomic layer of the first reactant such that a conform layer may be formed. In a subsequent flushing or evacuation step, unreacted gas of the first reactant and any reaction products may be removed from the reaction chamber such that only the layer formed by the reactant on the surface of the resistance layer may remain. In a further step, a second reactant may then be introduced into the reaction chamber and reacts in a self-limiting manner with the layer of the first reactant, which covers the resistance layer, to reactivate the layer formed by the first reactant for a reaction of the first reactant. After a further flushing or evacuation step to remove residues of the second reactant, said steps may be repeated as a respective cycle of the atomic layer deposition, wherein, due to the self-limiting character of the reactions, in each run in particular at most one atomic layer may be applied to the respective previously prepared layer or, in the first step, to the resistance layer of the electrical component. This makes it possible to reproduce the surface structure of the resistance layer in the respective process steps of the atomic layer deposition such that a conform covering of the resistance layer and a hermetic sealing may already be achieved at small layer thicknesses. Provision may generally also be made to use different materials in different cycles such that individual layers of the barrier layer applied by atomic layer deposition may be formed from different materials or different chemical compounds.

However, minor differences in the thickness of the barrier layer may, for example, also arise in an atomic layer deposition process when a respective process step is aborted or a flushing or evacuation step is initiated before a complete atomic layer has been formed and minor defects remain. However, these defects may be directly compensated in a subsequent step such that a complete hermetic sealing of the resistance layer may already be achieved from a thickness of the barrier layer of approximately 10 nanometers or of approximately 20 nanometers. In general, the thickness of the barrier layer may mainly be determined by the number of performed cycles of the atomic layer deposition. Provision may furthermore be made to perform cycles of the atomic layer deposition until the barrier layer has a thickness of approximately 50 nanometers up to approximately 500 nanometers or a thickness of approximately 100 nanometers to be able to achieve a reliable hermetic sealing during an efficient process performance. In general, a method of atomic layer deposition is, for example, explained in U.S. Pat. No. 4,058,430 A.

Further embodiments of the invention can be seen from the dependent claims, from the description, and from the Figures.

In some embodiments, a ratio between a minimum thickness and a maximum thickness of the barrier layer may be greater than 0.8 and in particular greater than 0.9. The barrier layer may thus be formed in a conform manner along the surface structure of the resistance layer and may enable a precise reproduction of the surface structure of the resistance layer without significant differences in the thickness such that a surface structure of a surface of the barrier layer at a side facing away from the resistance layer may substantially reproduce the surface structure of the resistance layer at the side facing away from the carrier. As explained, the thickness of the barrier layer may in particular be determined along a respective normal at the surface structure of the resistance layer at a specific measurement point, wherein minor thickness differences of the barrier layer may, for example, be caused by a small number of defects in individual layers, said defects being produced during an atomic layer deposition for applying the barrier layer.

In some embodiments, the thickness of the barrier layer may be less than a roughness of a surface of the carrier and/or less than a roughness of the surface structure of the resistance layer. As already explained, in a thin-film resistance component, a thickness of the resistance layer may be less than a roughness of the surface of the carrier to which the resistance layer is applied. Therefore, the surface structure of the resistance layer at the side facing away from the carrier may mainly be determined by the roughness of the surface of the carrier and may ultimately have a comparable roughness that is, however, slightly smaller than the surface of the carrier due to the thickness of the resistance layer. In such a case, the thickness of the barrier layer may thus be less than the roughness of the surface of the carrier and the roughness of the surface structure of the resistance layer. In a thick-film resistance component, the resistance layer may, in contrast, have a thickness that exceeds a roughness of the surface of the carrier such that the resistance layer may cover the roughness of the surface of the carrier and the surface texture of the resistance layer may be directly determined by its roughness, wherein the thickness of the barrier layer may be less than the roughness of the resistance layer. Irrespective of the design of the resistance layer, the barrier layer may, however, uniformly reproduce the surface structure without the roughness of the surface structure of the resistance layer being completely homogenized or depressions being completely filled.

The barrier layer may cover the resistance layer as a thin layer and may nevertheless enable a hermetic sealing. Due to such a barrier layer, a roughness of the surface structure of the resistance layer may thus not only be covered or depressions caused by roughness may thus not only be spanned, but the roughness of the surface structure may be directly reproduced by the barrier layer such that the surface of the resistance layer may be completely contacted by the barrier layer.

In some embodiments, the roughness of the surface structure of the barrier layer at its side facing away from the resistance layer may have a value that is in the range of 0.2 times to 1.0 times the value of the roughness of the surface structure of the resistance layer. Accordingly, the barrier layer may have a uniform thickness with at most minor deviations such that a surface structure of the barrier layer at a side facing away from the resistance layer may be substantially predefined by the roughness of the surface of the resistance layer.

Furthermore, in some embodiments, a roughness of the surface structure of the barrier layer at its side facing away from the resistance layer may be less than a roughness of the surface structure of the resistance layer. Due to the reproduction of the surface structure of the resistance layer, the barrier layer may in particular effect a certain homogenization but without completely eliminating a roughness of the surface structure of the resistance layer. In this regard, the surface structure of the barrier layer may also have a roughness at its side facing away from the resistance layer, said roughness being determined by the roughness of the surface structure of the resistance layer, but being reduced with respect to the roughness of the surface structure of the resistance layer due to the covering of the resistance layer.

In some embodiments, the surface structure of the resistance layer may form recesses, wherein the barrier layer may cover the recesses continuously and with a uniform thickness. Such a recess may in particular cover an overshadowed section of the surface of the resistance layer with respect to the surface normal of the overshadowed section such that the surface normal of the overshadowed section intersects the recess. Since the barrier layer may also cover the recesses with a constant thickness, i.e. the constant thickness, even such a recess does not result in a gap of the barrier layer. Rather, the barrier layer may be formed continuously and “pinhole-free” or without gaps. A covering of recesses may in particular be achieved by applying the barrier layer by means of an atomic layer deposition process, whereas directed processes, for example sputtering processes, that are conventionally used to form barrier layers may result in gaps of the barrier layer at such recesses due to shadowing effects.

In some embodiments, the surface structure of the resistance layer may, alternatively or additionally to the recesses described above, form open hollow spaces having wall sections, wherein the wall sections of a respective hollow space are disposed opposite one another with respect to the respective hollow space. The surface normals of the wall sections of the respective hollow space may in particular cross one another at an acute angle. In such embodiments, the barrier layer may cover the mutually oppositely disposed wall sections of the respective hollow space. Such an open hollow space may, unlike a mere depression of the surface of the resistance layer having a concave structure, further form a recess such that a normal of the surface of the resistance layer may in particular intersect a wall section of the hollow space or the recess at a lowest point of such a hollow space. The lowest point of the hollow space may be covered by the wall section or the recess along this normal. The opening of such a hollow space may, for example, be oriented upwardly, that is away from the carrier, obliquely upwardly, or laterally.

Since the barrier layer may cover the wall sections of such hollow spaces, such hollow spaces may also be covered and/or lined in a conform manner by the barrier layer. The barrier layer may thus not only close the opening of the hollow space such that a hollow space is produced between the resistance layer and the barrier layer, but the wall sections of the hollow space may also be covered by the barrier layer. Accordingly, a surface of the barrier layer facing away from the resistance layer may also have a hollow space having an opening at the respective position, wherein this hollow space may in particular likewise have a recess at the surface of the barrier layer. If necessary, the barrier layer may, however, completely fill hollow spaces or depressions in the surface structure of the resistance layer whose depth is less than the thickness of the barrier layer and/or whose wall sections have a smaller spacing from one another than twice the thickness of the barrier layer.

Furthermore, in some embodiments, the resistance layer may extend along a plane of extent, wherein at least one of the wall sections of a respective hollow space of the resistance layer may adopt an angle of >90 degrees with respect to the plane of extent of the resistance layer.

At least one of the wall sections of the respective hollow space may thus form a recess with respect to the plane of extent such that a surface normal of the at least one wall section may intersect the plane of extent of the resistance layer. The surface normal of the at least one wall section may in particular intersect the plane of extent of the resistance layer along a direction facing away from the wall section. The wall section may accordingly cover a lower point and in particular a lowest point of the hollow space with respect to a surface normal of the plane of extent of the resistance layer. However, such wall sections of a hollow space that so-to-say hang over with respect to the plane of extent may also be covered by the barrier layer with a uniform thickness corresponding to the other sections of the surface of the resistance layer such that no hollow space is produced between the wall section and the barrier layer that could impair the protection of the resistance layer.

In some embodiments, a surface of the carrier facing the resistance layer may form at least one recess, wherein the resistance layer may have a gap in the region of the recess. Furthermore, the barrier layer may cover the recess of the carrier and the resistance layer present in the environment of the gap continuously and with a uniform thickness. In such embodiments, the electrical resistance component may in particular be configured as a thin-film resistance component.

In particular on an application of the resistance layer by a directed process, a recess of the surface of the carrier may overshadow a section of the surface of the carrier with respect to a direction along which the material for forming the resistance layer is applied to the carrier such that the material does not reach the overshadowed section of the surface of the carrier and the recess. In these regions, a gap or a “pinhole” of the resistance layer may therefore be produced at the surface of the carrier. In contrast, the continuous barrier layer may also cover such gaps of the resistance layer and, in the region of the gaps, may cover the recess of the surface of the carrier and/or the overshadowed section, with the constant thickness. The continuous barrier layer may therefore be “pinhole-free” or formed without gaps even if the resistance layer has gaps. The carrier may in particular also form a hollow space having mutually oppositely disposed wall sections whose surface normals intersect at an acute angle, wherein the resistance layer may have a gap covered by the barrier layer with the constant thickness at least at one of the wall sections.

In some embodiments, the barrier layer may have a thickness of at most 1000 nanometers (nm). Alternatively or additionally, in some embodiments, the barrier layer may have a thickness of at least 5 nanometers (nm). The thickness of the barrier layer may in particular be in a range between 20 nanometers (nm) and 500 nanometers (nm) or in range between 100 nanometers (nm) and 500 nanometers (nm).

Such a thin barrier layer may in particular also enable an overall thin design of the electrical resistance component. In this respect, in particular on an application of the barrier layer by a process of atomic layer deposition, a barrier layer having a thickness of only 100 nm may already enable a completely hermetic sealing of the resistance layer to be able to protect said resistance layer with respect to moisture entering and in particular with respect to an influencing by water vapor. Due to a further thickening to approximately 500 nm, the hermetic sealing may be further safeguarded and individual steps during the application of the barrier layer may take place in an accelerated manner by, for example, not having to ensure that a complete layer without any defect is produced in each process step in a process of atomic layer deposition.

In some embodiments, the barrier layer may comprise a plurality of atomic layers that extend in parallel above one another and that reproduce the surface structure of the resistance layer. The barrier layer may in particular comprise a plurality of continuous atomic layers or approximately continuous atomic layers that are disposed above one another. For example, each of the atomic layers may reproduce the surface structure of the resistance layer with a uniform thickness, wherein individual atomic layers may indeed possibly have minor defects, but such defects may be compensated by the subsequent atomic layers. The respective atomic layers may in particular also have the features explained above for the barrier layer and may, for example, cover a wall section of a hollow space, a recess formed by the surface structure of the resistance layer, a recess formed by the surface of the carrier, and/or a gap of the resistance layer with a constant thickness. The plurality of atomic layers of the barrier layer may consist of the same material or different atomic layers may be formed from materials different from one another.

In embodiments having different materials, the barrier layer may have an arrangement of a plurality of (e.g. at least ten) atomic layers of a first material A above one another and, above such an arrangement, the barrier layer may have at least one further arrangement of a plurality of (e.g. at least ten) atomic layers of a second material B different from the first material A above one another. Optionally, above the further arrangement, the barrier layer may further have at least one arrangement of a plurality of (e.g. at least ten) atomic layers of a third material C above one another. Furthermore, in some embodiments, a repetition of such layer arrangements may be provided such that the barrier layer may have a sequence of a plurality of different layer arrangements in accordance with the scheme ABAB . . . or in accordance with the scheme ABCABC . . . above one another.

In some embodiments, the barrier layer may have an amorphous structure. Whereas, in crystalline barrier layers, grain boundaries may occur due to lattice defects, at which grain boundaries regions of the crystal of different orientations abut one another, an amorphous structure of the barrier layer may enable a uniform and hermetic covering of the resistance layer. The barrier layer may thus be formed without cracks or interruptions, in particular also in individual atomic layers, that could impair the reliable sealing of the resistance layer with respect to environmental influences and in particular moisture. For example, such an amorphous structure of the barrier layer may be achieved by atomic layer deposition.

Alternatively or additionally, in some embodiments, the barrier layer may have a semi-crystalline structure. A semi-crystalline structure may in particular be formed by a plurality of small crystals that are connected to one another at respective grain boundaries. In such a structure, crystallizations may thus in particular take place sectionally, wherein a continuous crystalline structure is not produced, however. For example, semi-crystalline structures may be produced in the course of an atomic layer deposition for applying the barrier layer in that the respective reactions for forming a layer take place with a slight time delay such that crystals, but not continuous crystals, may form sectionally and then abut one another at grain boundaries in order to form the respective layer.

In some embodiments, the barrier layer may be formed in multiple layers, as already mentioned. In an atomic layer deposition, individual layers may in particular be applied in a plurality of process steps and/or cycles and may ultimately jointly form the barrier layer. The layers may in particular be the already mentioned plurality of atomic layers extending in parallel above one another.

In some embodiments, the barrier layer may have at least one layer having an amorphous structure. Alternatively or additionally, in some embodiments, the barrier layer may have at least one layer having a semi-crystalline structure. In some embodiments, the barrier layer may in particular have at least one layer having an amorphous structure and at least one layer having a semi-crystalline structure.

Furthermore, in some embodiments, the barrier layer may have a first layer formed from a first material and a second layer formed from a second material, wherein the first material and the second material may differ from one another. If the barrier layer, as already explained, has a plurality of arrangements of a respective plurality of layers of different materials, a plurality of atomic layers of the same material may first be deposited in plurality of process cycles in an atomic layer deposition process to form a first layer arrangement. After a predetermined number of atomic layers, an atomic layer of another material may be deposited by, for example, changing the previously used reactants. A plurality of atomic layers of this other material may subsequently also be deposited again to jointly form a second layer arrangement of the barrier layer. Optionally, a repeating sequence of a plurality of different layer arrangements may be formed in this manner and/or more than two different materials may be provided for the different layer arrangements.

Provision may, for example, be made to form a first layer of the barrier layer, in particular by means of atomic layer deposition, from a material that covers the resistance layer as an amorphous structure. Thereupon, a subsequent layer may, for example, be provided for which a material is used that forms a semi-crystalline structure. The barrier layer may generally be formed from any desired combinations of layers of an amorphous structure and layers of a semi-crystalline structure. However, provision may also be made that all of the plurality of layers of the barrier layer have an amorphous structure or a semi-crystalline structure and/or are formed from the same material. However, the use of different materials and/or layers of a different structure may possibly further increase the impermeability of the barrier layer with respect to moisture.

In some embodiments, the barrier layer may be formed as electrically insulating or as semiconductive. During the intended use of the electrical component, no current flow may thus in particular take place between the barrier layer and the electrical connector.

In some embodiments, the electrical resistance component may in particular comprise two electrical connectors that are attached to the carrier and that are connected to one another by the resistance layer.

Furthermore, in some embodiments, the barrier layer may be formed as hermetically sealing. The barrier layer may thus provide reliable protection of the resistance layer with respect to moisture in liquid form and/or in vapor form.

In some embodiments, the barrier layer may be formed by atomic layer deposition onto the resistance layer.

As already explained, the application of the barrier layer by atomic layer deposition may make it possible to thinly apply the barrier layer to the carrier and to cover the surface of the resistance layer with a uniform thickness such that a conform barrier layer having an inorganic material may be formed. The application of the barrier layer by atomic layer deposition may thus in particular enable said precise reproduction of the surface structure of the resistance layer. Furthermore, an atomic layer deposition may be performed in a large process window or in a large temperature range such that the barrier layer may be gently applied to the resistance layer and damage to the resistance layer or a change in its electrical characteristics by the application of the barrier layer may be avoided. The resistance layer may thus be covered by a thin, inorganic barrier layer through atomic layer deposition, wherein both a high level of protection of the resistance layer with respect to environmental influences and in particular with respect to damage by corrosion as a result of moisture entering may be achieved and it may be ensured that the previously defined electrical properties of the electrical resistance component, for instance a precisely trimmed resistor, are not changed or impaired by the application of the barrier layer. Thus, such a barrier layer makes it possible to achieve the required accuracy of electrical resistance components and to ensure their long-term stability with respect to environmental influences and under load.

In some embodiments, the barrier layer may comprise a metal oxide, a semiconductor oxide, a metal nitride, a semiconductor nitride, a metal oxynitride, and/or a semiconductor oxynitride. In such embodiments, the barrier layer may in particular comprise aluminum oxide (Al₂O₃), titanium oxide (TiO₂), titanium nitride (TiNₓ), hafnium dioxide (HfO₂), zirconium dioxide (ZrO₂), and/or tungsten oxide (WO).

Such materials are in particular suitable to be applied to the resistance layer by means of atomic layer deposition, for which purpose relatively large process windows and/or temperature ranges are in particular available. For example, an aluminum oxide layer may be applied to the resistance layer in a temperature range of approximately 20° C. to 400° C. by means of atomic layer deposition.

As already explained, the barrier layer may in particular comprise a plurality of layers of different materials, wherein the above-mentioned materials or groups of materials may in particular be considered for the respective layers.

In some embodiments, the barrier layer may be at least partly covered by a protective layer. Such a protective layer may enable additional protection of the resistance layer with respect to environmental influences in that the barrier layer may already be shielded with respect to moisture influences by the protective layer. However, the protective layer—due to the already conform covering of the resistance layer by the barrier layer—does not necessarily have to cover the barrier layer in a conform manner. Rather, minor hollow spaces between a surface of the barrier layer at a side facing away from the resistance layer and the protective layer may, for example, be tolerable since the resistance layer may already be reliably protected by the barrier layer and in particular against liquid possibly entering these hollow spaces and/or collecting there. The protective layer may thus extend the protection of the resistance layer against environmental influences, but may possibly develop a smaller protective effect than the barrier layer and may therefore be applied in a simple manner.

In some embodiments, the protective layer may comprise an organic material. In some embodiments, the protective layer may in particular be formed from an organic material and/or consist of an organic material. Furthermore, in some embodiments, the protective layer may alternatively or additionally comprise an inorganic material. A combination of organic and inorganic materials may also be provided to form the protective layer.

A protective layer, in particular an organic protective layer, may form an advantageous addition to an inorganic barrier layer in that the organic protective layer may already form a reliable protection of the resistance layer with respect to moisture in liquid form, for instance by dew, while the conform, inorganic barrier layer may complete the protection of the resistance layer in particular with respect to moisture in vapor form. The protective layer as an organic layer may also be thin such that the barrier layer and the protective layer may jointly form a thin covering of the resistance layer to fully protect it with respect to an influence of moisture.

In addition to the dual protective effect, such a protective layer and in particular an organic protective layer may also be used as an etching mask during the manufacture of the electrical resistance component to be able to remove the previously applied barrier layer wet chemically in a region of the electrical connector, for example. This makes it possible to omit any additional structuring steps in order, for instance, to be able to remove a barrier layer, which is applied by atomic layer deposition and which may cover the total surface of the part of the electrical resistance component subjected to the process of atomic layer deposition, in specific regions again. Rather, this may take pace in a comfortable and simple manner by a subsequent etching step using the protective layer as an etching mask.

In some embodiments, the protective layer may, for example, comprise an epoxy resin, a polyimide, a polyamide, a polyimide-amide, a silicone resin, an acrylate, a polyurethane, and/or silicon dioxide (SiO₂).

The resistance layer may have a trimming structure in some embodiments. For example, a resistance value of the resistance layer may be precisely defined by such a trimming structure.

The trimming structure may in particular form incisions and/or constrictions of the resistance layer along a plane of extent of the resistance layer. Due to such incisions or constrictions, the trimming structure may in particular interrupt the surface of the resistance layer such that the trimming structure may not be part of the surface structure along the surface of the resistance layer, but may form a larger structure with respect thereto. The incisions and/or constrictions may in particular extend from the surface of the resistance layer up to a surface of the carrier and may completely cut through the resistance layer. For example, a trimming structure may be formed lithographically or by laser structuring after the resistance layer has been applied to the carrier.

In some embodiments, the resistance layer may comprise chromium, nickel, or a cermet. Furthermore, the resistance layer may, for example, comprise silicon, tantalum, molybdenum, niobium, aluminum, copper, titanium, carbon, and/or tantalum nitride. The resistance layer may in particular be configured as a thin-film resistor, wherein in particular thin-film resistors may be susceptible with respect to corrosion due to the small layer thickness and may therefore require reliable protection with respect to moisture. Alternatively thereto, the resistance layer may, for example, be configured as a thick-film resistor, wherein in particular such a thick-film resistor may comprise a cermet. Cermet thick-film resistors may also be undesirably influenced by corrosion such that a reliable sealing with respect to moisture is equally necessary for such thick-film resistors.

The resistance layer may be planar in some embodiments. In such embodiments, the carrier may in particular be cuboid, wherein the resistance layer may be formed at a surface of the carrier.

Alternatively thereto, the resistance layer may be hollow cylindrical in some embodiments. In such embodiments, the carrier may in particular be cylindrical, wherein the resistance layer may peripherally surround the carrier. Furthermore, in such embodiments, the electrical connector may be configured as a cap that covers one end face of the carrier and/or two mutually oppositely disposed electrical connectors may be formed at the carrier that are configured as a respective cap at one end face of the cylindrical carrier.

Furthermore, in some embodiments, the resistance layer may be meandering or spiral. In general, the shape of the resistance layer may be determined by the shape of the carrier that may in particular depend on the intended use of the resistance component.

In some embodiments, the carrier may comprise a ceramic substrate and may in particular comprise aluminum oxide (Al₂O₃), aluminum nitride (AlN), and/or silicon dioxide (SiO₂). The carrier may in particular be produced from and/or consist of a ceramic substrate.

The invention further relates to a method of manufacturing an electrical resistance component and in particular an electrical resistance component in accordance with any one of the embodiments explained above, comprising the steps:
providing an electrically insulating carrier;
attaching at least one electrical connector to the carrier;
applying at least one resistance layer to the carrier, wherein the resistance layer has a surface structure along its surface at a side facing away from the carrier; and
covering the resistance layer with a barrier layer that comprises an inorganic material and that reproduces the surface structure of the resistance layer continuously and with a uniform thickness.

For example, the resistance layer may be applied to the carrier after or before the at least one connector element and the resistance layer may be applied such that it contacts the connector element. Furthermore, two respective electrical connectors may be attached to the carrier at mutually oppositely disposed sides. An electrical connector may in particular be additively attached to the carrier by screen printing and by a subsequent burning in of conductive metal pastes. The resistance layer may, for example, be configured as a thin-film resistor and may be applied to the carrier by a physical vapor deposition process and/or may form a thin metal layer that may, for example, comprise nickel, chromium, or cermet. Alternatively thereto, the resistance layer may be configured as a thick-film resistor and may in particular be applied to the carrier as a paste, in particular as a glass paste having metal particles or having metal oxide particles, by means of screen printing.

Provision may further be made that the resistance layer has a current-conducting layer that is applied to the carrier and that may be covered by an additional, but non-conform and/or non-continuous additional material layer before the covering of the resistance layer by the barrier layer in order to stabilize the current-conducting layer of the resistance layer. Such an additional material layer of the resistance layer may in particular be applied to the current-conducting layer by sputtering, wherein, in such embodiments, the current-conducting layer and the additional material layer jointly form the resistance layer that may then be uniformly covered by the barrier layer. In general, however, the resistance layer may also be formed solely by a current-conducting layer.

As already explained above, a reliable sealing of the resistance layer by the barrier layer with respect to entering moisture may be achieved by the precise reproduction of the surface structure of the resistance layer that may, for example, be determined on the basis of irregularities during a physical gas deposition process for applying the resistance layer, or by a roughness of the surface of the carrier, or by a roughness that arises on an application of the resistance layer by screen printing. Since the barrier layer also comprises an inorganic material, reliable protection may in particular also be achieved with respect to moisture in vapor form.

In some embodiments, the barrier layer may be applied to the resistance layer by atomic layer deposition. This in particular enables the application of the barrier layer in a relatively large process window or in a relatively large temperature range. The barrier layer may be successively applied to the resistance layer in the course of the atomic layer deposition process, in particular by a plurality of parallel atomic layers, to reproduce the surface structure of the resistance layer with a uniform thickness that may be substantially determined by the number of atomic layers or the number of consecutively performed cycles of the atomic layer deposition process. A hermetic sealing of the resistance layer and in particular of all the regions of the resistance layer may hereby be achieved, wherein, for example, hollow spaces formed by the surface structure, recesses formed by the surface structure of the resistance layer, recesses formed by the surface of the carrier, and/or gaps of the resistance layer may also be uniformly covered or lined by the barrier layer.

In some embodiments, the resistance layer may be covered by a plurality of layers that jointly form the barrier layer. As already explained above, this may in particular take place by atomic layer deposition in that respective atomic layers, which cover the previously produced layers, are produced in consecutive cycles of the atomic layer deposition.

Furthermore, in some embodiments, a first layer of the plurality of layers may be formed from a first material and a second layer of the plurality of layers may be formed from a second material, wherein the first material and the second material may differ from one another. The barrier layer may in particular be formed as a laminate of layers of different materials, wherein in particular said materials already mentioned above may be considered for the individual layers.

Alternatively or additionally, in some embodiments, at least one layer of the plurality of layers may have an amorphous structure and/or at least one layer of the plurality of layers may have a semi-crystalline structure. The barrier layer may in particular have both layers of a semi-crystalline structure and layers of an amorphous structure to be able to achieve as impermeable as possible a sealing of the resistance layer. For example, such amorphous and/or semi-crystalline layers may be formed by selecting suitable materials in an atomic layer deposition process for producing the respective layer.

In some embodiments, the barrier layer may have a thickness of at most 1000 nanometers (nm). Alternatively or additionally, the barrier layer may have a thickness of at least 5 nanometers (nm). An applied barrier layer that was applied to the resistance layer by atomic layer deposition may in particular already form a reliable sealing of the resistance layer at such a thickness, wherein the barrier layer may in particular already be completely hermetically sealing at a thickness of 10 nm, 20 nm, or 100 nm. The barrier layer may therefore in particular have a thickness of approximately 10 nm, approximately 20 nm, approximately 50 nm, or approximately 100 nm.

In some embodiments, a protective layer may be applied to the barrier layer. Due to such a protective layer, the protection of the resistance layer already provided by the barrier layer with respect to environmental influences and in particular moisture may be completed in order, for example, already to keep moisture in liquid form away from the barrier layer.

In some embodiments, the protective layer may comprise an organic material. This may in particular prevent a passage of moisture in liquid form, whereas the barrier layer comprising an inorganic material may prevent a passage of moisture in vapor form to the resistance layer. Due to the cooperation of the protective layer and the barrier layer, the resistance layer may thus be completely protected with respect to influences of moisture. Furthermore, in some embodiments, the protective layer may comprise an inorganic material and/or a combination of organic and inorganic materials.

In some embodiments, the protective layer may be applied to the barrier layer in a structured manner by means of screen printing.

Furthermore, in some embodiments, the barrier layer may be removed wet chemically in the region of the connector element, wherein the protective layer may be used as an etching mask. Since the protective layer may in particular be applied to the barrier layer in a structured manner, the protective layer may be applied to the barrier layer such that the sections of the barrier layer required to protect the resistance layer are covered by the protective layer and may thus be retained during the etching. In contrast, sections of the barrier layer that cover the at least one electrical connector may be easily removed wet chemically by using the protective layer as an etching mask without further and complex structuring steps of the barrier layer being necessary.

The barrier layer may in particular cover the resistance layer beyond respective edges of the surface of the resistance layer such that the resistance layer may be surrounded by the carrier at a side facing the carrier and may be surrounded by the barrier layer at all further sections. The resistance layer may thus be completely surrounded and hermetically sealed, in particular also after a wet chemical removal of the barrier layer in the region of the electrical connector.

Furthermore, in some embodiments, the resistance layer may be provided with a trimming structure before the application of the barrier layer. This may in particular take place lithographically and/or by a laser structuring. Such a trimming structure may, for example, make it possible to precisely define an electrical resistance of the resistance layer, wherein the trimming structure may, for example, form incisions and/or constrictions in the resistance layer.

Said steps for manufacturing an electrical resistance component may in particular take place at a wafer level by jointly performing the steps for a plurality of mutually connected electrical resistance components and then separating, in particular sawing up, the electrical resistance components.

Furthermore, the invention is also directed to an electrical resistance component that is manufactured by a method in accordance with the embodiments explained. The invention in particular also relates to an electrical resistance component that is manufactured in the method in accordance with the embodiments explained.

### BRIEF DESCRIPTION OF THE DRAWINGS

The invention will be explained in the following purely by way of example with reference to embodiments and to the drawings.

There are shown:

FIGS. 1A to 1F a respective schematic representation of an electrical resistance component, which is configured as an electrical resistance component, in different steps of a method of manufacturing the electrical resistance component;

FIGS. 2A and 2B a respective schematic detailed view of a section of an electrical resistance component that is configured as a thick-film resistance component and that has a resistance layer having a surface structure along its surface that is covered by a barrier layer reproducing the surface structure with a uniform thickness, wherein a protective layer covering the barrier layer is additionally shown in FIG. 2B;

FIGS. 3A to 3C a respective further schematic detailed view of a section of the electrical resistance component for illustrating the formation of the barrier layer with a plurality of atomic layers, a trimming structure formed at the resistance layer, a hollow space of the surface of the resistance layer reproduced by the barrier layer, and a resistance layer that comprises a current-conducting layer and an additional material layer;

FIGS. 4A to 4D a respective schematic detailed view of a section of an electrical resistance component corresponding to FIG. 2A or 2B, wherein the resistance component is, however, configured as a thin-film resistance component, and a schematic detailed view for illustrating a trimming structure formed at the resistance layer, and a schematic detailed view for illustrating a gap of the resistance layer produced by a shadowing effect; and

FIGS. 5A and 5B a perspective representation and a cross-sectional representation of an embodiment of the electrical resistance component that has a cylindrical carrier.

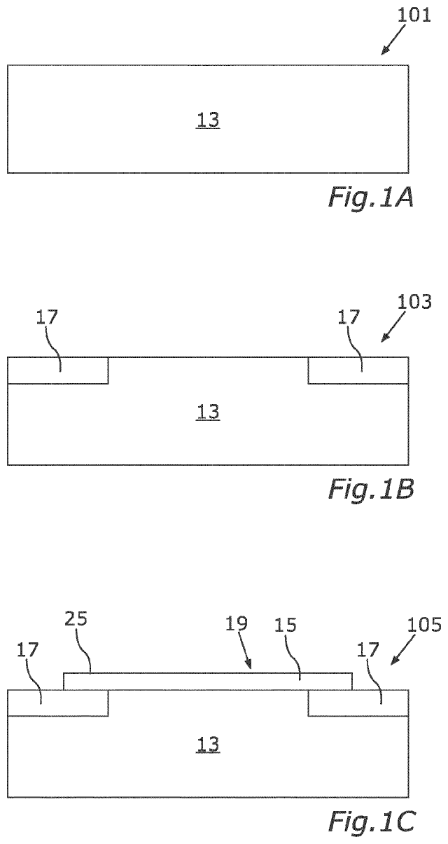

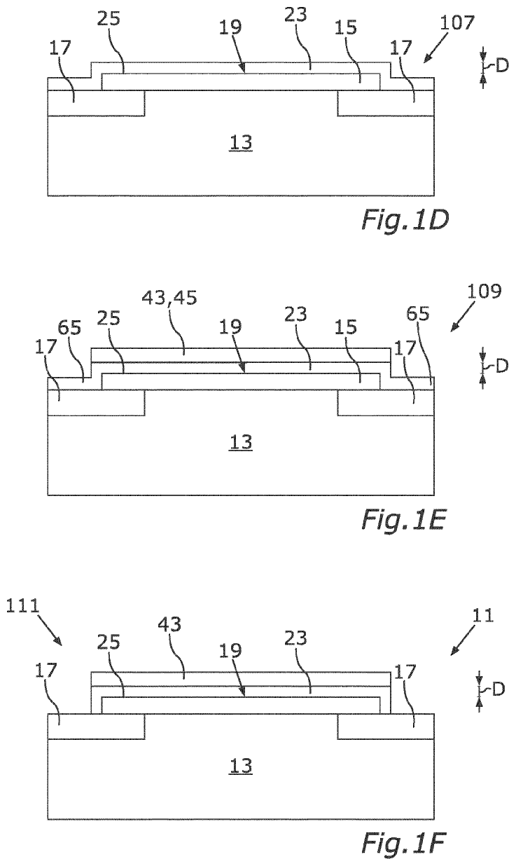

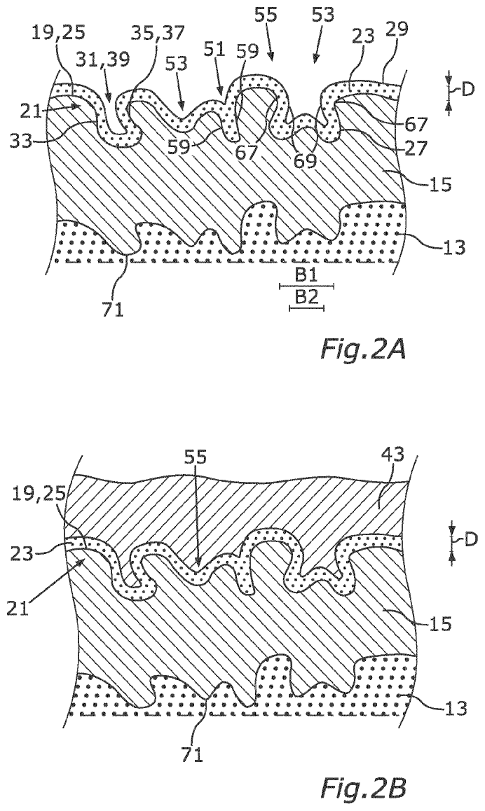

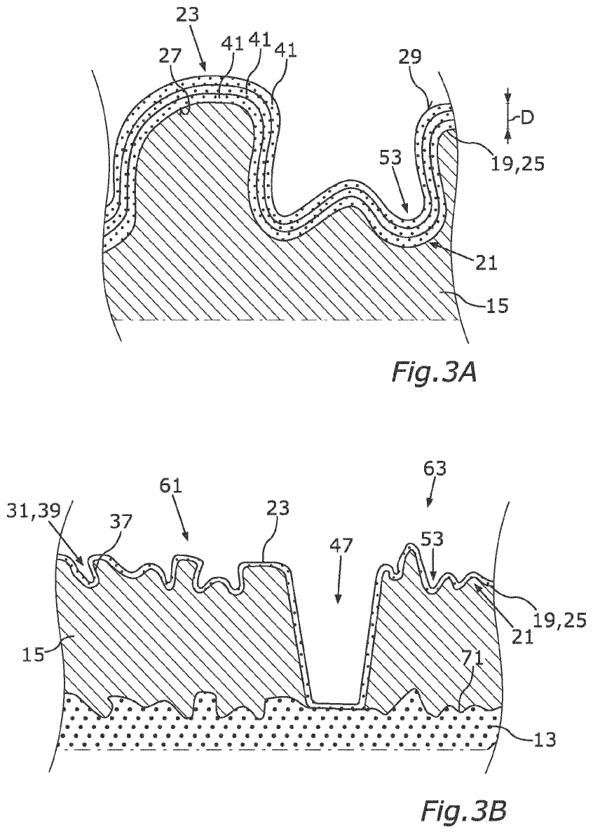

FIGS. 1A to 1F schematically illustrate a method of manufacturing an electrical resistance component 11, wherein the complete electrical resistance component 11 is schematically shown in a cross-sectional representation in FIG. 1F.

### DETAILED DESCRIPTION

In a first step 101 shown in FIG. 1A, an electrically insulating carrier 13, which is parallelepiped-shaped by way of example here, is provided in this method. The carrier 13 may in particular comprise a ceramic substrate and may, for example, be formed from and/or consist of aluminum oxide (Al₂O₃).

In a subsequent step 103 shown in FIG. 1B, two electrical connectors 17 are attached to the carrier 13, wherein the connectors 17 may, for example, be attached by screen printing and a subsequent burning in of conductive metal pastes. The two electrical connectors 17 may in particular form respective electrical contacts via which the electrical resistance component 11 may be electrically connected to further components.

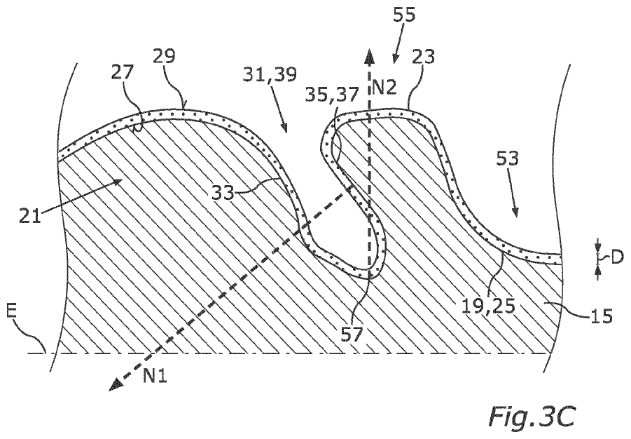

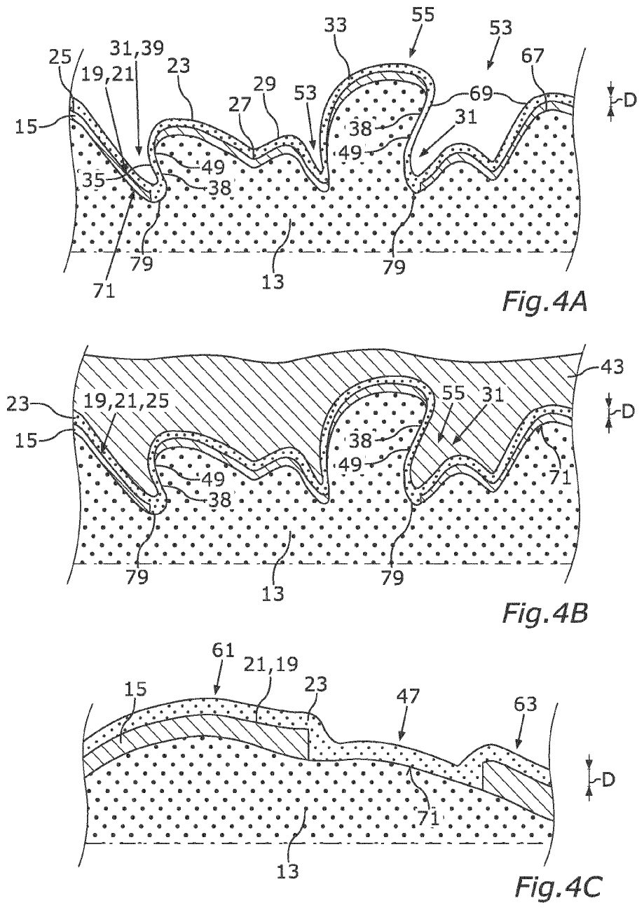

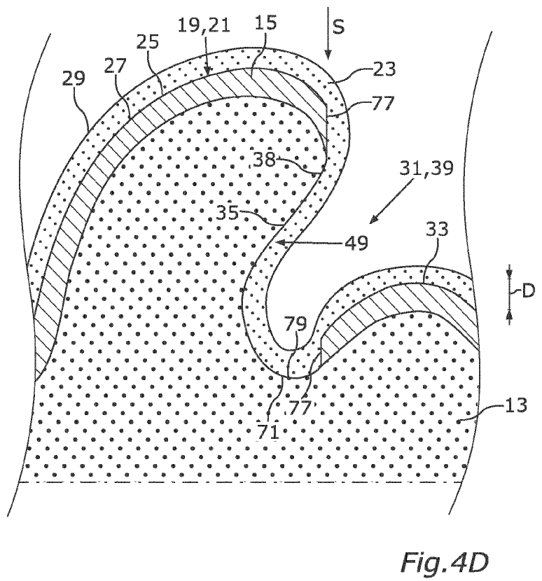

In a step 105, a resistance layer 15 is then applied to the carrier 13, wherein the resistance layer 15 connects the two electrical connectors 17 to one another. For example, the resistance layer 15 may be applied to the carrier 13 by physical vapor deposition and may form a thin metal layer, wherein a sputtering process, in which a directed material application takes place, may in particular be used to apply the resistance layer 15. The resistance component 11 may in particular be configured as a thin-film resistance component (also designated as a thin-layer resistance component) by such an application of the resistance layer 15, wherein the resistance layer 15 may have a thickness in the range of 50 nanometers to 500 nanometers (cf. in this respect also FIGS. 4A to 4D). Alternatively thereto, the resistance component 11 may, however, also be configured as a thick-film resistance component, wherein the resistance layer 15 of such a resistance component 11 may, for example, be formed by a glass paste comprising metal particles or metal oxide particles and may be applied to the carrier 13 by means of screen printing (cf. in this respect also FIGS. 2A to 3C). A resistance layer 15 applied to the carrier 13 in such a manner may, for example, have a thickness of up to 10 um. Furthermore, it is also possible to first apply or attach the resistance layer 15 and then the electrical connectors 17 to the carrier 13.

For example, the resistance layer 15 may be formed by a thin metal layer that may, for example, comprise nickel or chromium and that may in particular be applied to the carrier 13 by means of physical vapor deposition. Alternatively thereto, a resistance layer may, for example, be formed by a cermet thick film. A formation from nickel or chromium, however, in particular makes it possible to apply the resistance layer 15 as a thin-film resistor to the carrier 13 such that a flat design of the electrical resistance component 11 or of the resistance component may be achieved.

To be able to define a specific electrical resistance at the resistance layer 15, the resistance layer 15 may be provided with a trimming structure 47 in a step not illustrated in FIGS. 1A to 1F by forming incisions and/or constrictions in the resistance layer 15 lithographically or by means of laser structuring, for example. Such incisions or constrictions may interrupt or separate sections of the resistance layer 15 from one another with respect to a plan view and may extend through the resistance layer 15 up to the carrier 13 with respect to a side view (cf. also FIGS. 3B and 4C). For example, provision may therefore be made to provide the resistance layer 15 with a trimming structure 47 between the steps illustrated in FIGS. 1C and 1D.

Irrespective of the above-explained trimming structure 47 by which in particular interruptions deliberately reaching up to the carrier 13 may be formed at the resistance layer 15, the resistance layer 15 has, at a side 25 facing away from the carrier 13, a surface 19 having a surface structure 21 that may, for example, determine a roughness of the surface 19 of the resistance layer 15 (cf. FIGS. 2A to 4D). In contrast to the deliberately applied trimming structure 47, the surface structure 21 may mainly be caused by the process for applying the resistance layer 15 to the carrier 13 in that different structures or heights of the resistance layer 15 may, for example, be formed with respect to the carrier 13 during a sputtering process and/or a screen printing process and may be reflected in a microscopic, not intentionally generated surface structure 21 having a roughness in the range of approximately 0.1 μm to 3 μm.

Furthermore, in particular in a configuration of the resistance component 11 as a thin-film resistance component, a thickness of the resistance layer 15 may be less than a roughness of a surface 71 of the carrier 13 to which the resistance layer 15 is applied (cf. FIGS. 4A to 4D). In such an electrical resistance component 11, the surface structure may therefore be substantially determined by the roughness of the surface 71 of the carrier 13. For example, the roughness of the surface 71 of the carrier 13 may be in a range of 1 μm to 3 μm, while the thickness of the resistance layer 15 of a resistance component 11 configured as a thin-film resistance component may be in a range of 50 nanometers to 500 nanometers. In the case of a resistance component 11 configured as a thick-film resistance component, a thickness of the resistance layer may, in contrast, amount to up to 10 μm and may thus exceed a roughness of the surface 71 of the carrier such that the surface structure 21 of the resistance layer 15 may be determined by the roughness of the resistance layer 15 itself in such a case (cf. FIGS. 2A to 3C). Such a roughness may be in the above-mentioned range of approximately 0.1 μm to 3 μm and may thus substantially correspond to the roughness of the surface 71 of the carrier 13.

In the case of electrical resistance components 11, there is a generally the requirement to make these electrical resistance components 11 as small and in particular flat or thin as possible, but at the same time to ensure a high accuracy and stability over a long time period and under load. For example, it may be necessary for a resistance set at a resistance layer 15 formed as a resistance layer to experience at most a change of 0.1% over a long period of use, for example, 1000 hours at a 10% nominal load. Furthermore, a high accuracy of the set resistance value is necessary, wherein a tolerance of, for example, between 1% and 0.01% may be required. However, due to the small layer thickness, the thin resistance layers 15 required often have a high sensitivity with respect to a corrosion by anodic oxidation on a simultaneous application of an electrical voltage such that the long-term stability of such an electrical resistance component 11 may be impaired by a contact with moisture.

Therefore, in a step 107 shown in FIG. 1D, the resistance layer 15 is covered by a barrier layer 23 that comprises an inorganic material and that reproduces the surface structure 21 of the covered resistance layer 15 with a uniform thickness D (cf. also FIGS. 2A to 4D). The barrier layer 23 may in particular be applied to the resistance layer 15 by atomic layer deposition to be able to precisely reproduce the surface structure 21 of said resistance layer 15 at the side 25 facing away from the carrier 13. Such an atomic layer deposition may in particular make it possible to form the barrier layer 23 as a conform layer having a uniform thickness D in order to precisely reproduce the surface structure 21 of the resistance layer 15. Furthermore, an atomic layer deposition may take place in a relatively broad process window or in a broad temperature range such that the barrier layer 23 may be gently applied to the resistance layer 15 and it may be ensured that, for example, a resistance set at the resistance layer 15 is not changed by the application of the barrier layer 23.

Since the barrier layer 23 comprises an inorganic material, the barrier layer 23 may in particular provide reliable protection of the resistance layer 15 with respect to moisture in vapor form, wherein the barrier layer 23 may hermetically seal the resistance layer 15. For this purpose, different materials may be considered for the barrier layer 23 and the barrier layer 23 may, for example, comprise a metal oxide, a semiconductor oxide, a metal nitride, a semiconductor nitride, a metal oxynitride, and/or a semiconductor oxynitride. The barrier layer 15 may in particular comprise aluminum oxide (Al₂O₃ or Al₂O₃:N), titanium oxide (TiO₂), titanium nitride (TiNₓ), hafnium dioxide (HfO₂), zirconium dioxide (ZrO₂), and/or tungsten oxide (WO) that may, for example, be applied to the resistance layer by atomic layer deposition. In a design of the barrier layer 23 with the aforementioned materials, the barrier layer 23 may furthermore in particular be formed as electrically insulating or as semiconductive such that a current flow through the electrical resistance component 11 or between the two connectors 17 may take place completely through the resistance layer 15 and a predefined resistance value of the electrical resistance component 11 may, for example, be precisely predefined.

Furthermore, the barrier layer 23 may have an amorphous structure that may, for example, likewise be produced directly as a result of an application of the barrier layer 23 by means of atomic layer deposition. In comparison to crystalline structures, such an amorphous structure may be uniformly formed and may in particular not have any grain boundaries at which differently oriented sections of a crystal adjoin one another. While such grain boundaries may form undesirable fractures in a crystalline structure and may impair the sealing of the resistance layer 15, a reliable sealing in particular against moisture in vapor form may be achieved by an amorphous and inorganic barrier layer 23. Alternatively or additionally, the barrier layer 23 may, however, also have a semi-crystalline structure.

FIGS. 2A to 4D show schematic detailed views to illustrate the reproduction of the surface structure 19 of the resistance layer 15 by the barrier layer 23. In FIGS. 2A to 3C, an electrical resistance component 11 is illustrated that is configured as a thick-film resistance component in which a thickness of the resistance layer 15 exceeds a roughness of the surface 71 of the carrier 13. In contrast, in FIGS. 4A to 4D, an electrical resistance component 11 is schematically illustrated which is configured as a thin-film resistance component and in which the roughness of the surface 71 of the carrier 13 is greater than the thickness of the resistance layer 15. Due to the merely schematic representation, no precise size or length ratios can furthermore be seen from FIGS. 2A to 4D, however. The ratios between a thickness of the resistance layer 15 and its roughness or a ratio between the thickness D of the barrier layer 23 and the thickness of the resistance layer 15 in particular do not always have to precisely correspond to the respective representation in FIGS. 2A to 4D.

As, for example, FIGS. 2A and 4A show, due to the formation of the barrier layer 23 with a uniform thickness D, the three-dimensional course of a surface structure 55 of the barrier layer 23 at a side 29 of the barrier layer 23 that faces away from the resistance layer 15 precisely follows the surface structure 21 of the resistance layer 15 along its surface 19 at the side 25 that faces away from the carrier 13. Basically, the surface structure 55 of the barrier layer 23 thus corresponds to the surface structure 21 of the resistance layer 15, wherein, however, a width B1 of a depression 53 or a spacing between two sections 67 at the surface 19 of the resistance layer 15 may, for example, be reduced by twice the thickness D of the barrier layer 23 in the case of the corresponding depression 53 in the surface structure 55 of the barrier layer 23. A width B2 or a spacing between two sections 69 at the surface 55 of the barrier layer 23 that are formed at the same height as the sections 67 at the surface 19 of the resistance layer 15 may thus correspond to the width B1 reduced by twice the thickness D of the barrier layer 23.

Since the barrier layer 23 reproduces the surface structure 21 of the surface 19 of the resistance layer 15, the surface structure 55 of the barrier layer 23 thus so-to-say follows the course of the surface structure 21 of the surface 19 of the resistance layer 15 at a spacing that corresponds to the thickness D of the barrier layer 23. In contrast, a structure of the barrier layer 23 at a side 27 facing the resistance layer 15 in particular corresponds to the surface structure 21 of the surface 19 of the resistance layer 15 in that, at the side 27, the barrier layer 23 directly adjoins the resistance layer 15 and contacts the resistance layer 15 or its surface 19. The surface 19 of the resistance layer 15 may therefore in particular be contacted by the barrier layer 23 at every position.

FIG. 2A further shows that the surface structure 21 of the surface 19 of the resistance layer 15 may form an open hollow space 31 that is bounded by two mutually oppositely disposed wall sections 33 and 35 in the cross-section shown. The hollow space 31 furthermore has an opening 39 that is oriented upwardly, i.e. that faces away from the carrier 13. Unlike depressions 53 that are likewise formed at the surface structure 21, the hollow space 31 is bounded by a recess 37 of the resistance layer 15, said recess 37 being formed by the wall section 35 and so-to-say hanging over with respect to a plane of extent E of the resistance layer 15 (cf. also FIG. 3C).

Despite this recess 37 of the resistance layer 15, the barrier layer 23 covers the two wall sections 33 and 35 of the hollow space 31 of the surface structure 21, and thus also the recess 37, with the uniform thickness D and completely lines the hollow space 31 (cf. also FIG. 3C). The surface of the hollow space 31 of the resistance layer 15, including the recess 37, is uniformly covered by the barrier layer 23 such that the surface structure 55 of the barrier layer 23 at the side 29 that faces away from the resistance layer 15 likewise has a hollow space having an opening in the region of the hollow space 31. In this regard, the barrier layer 23 in particular does not close the opening 39 of the hollow space 31 of the surface structure 21 of the surface 19 of the resistance layer 15 and no hollow space is produced between the resistance layer 15 and the barrier layer 23 that could impair the sealing of the resistance layer 15 by the barrier layer 23 or the stability of this sealing.

In the embodiment of a thick-film resistance component illustrated in FIGS. 2A to 3C, the wall sections 33 and 35 and the hollow space 31 of the resistance layer 15 are formed by the resistance layer 15 itself. In contrast, in the embodiment of a thin-film resistance component illustrated by means of FIGS. 4A to 4D, the surface 71 of the carrier 15 has two recesses 38 and the resistance layer 15 has a respective gap 49 or a “pinhole” in the region of the recesses 38 of the carrier 15. Such gaps 49 may in particular be produced due to a shadowing effect during an application of the resistance layer 15 to the carrier 13 if the resistance layer 15 is applied by a directed process, for instance, a sputtering process. As the enlarged view in accordance with FIG. 4D illustrates, the material used for forming the resistance layer 15, when the material is applied directed along a direction S, may not reach the recess 38 of the surface 71 of the carrier 13 and a section 79 of the surface 71 of the carrier 13 that is overshadowed by the recess 38 with respect to the direction S such that the gap 49 is not produced in the resistance layer 15. Furthermore, in the case of a resistance component 15 configured as a thin-film resistance component, the resistance layer 15 may have an additional material layer, not shown in the Figures, at its upper side to stabilize a current-conducting part of the resistance layer 15. Such an additional layer may in particular also be applied by a directed process to the current-conducting layer of the resistance layer 15 such that the shadowing effects explained above may likewise occur with the additional material layer and the additional material layer may not be formed continuously and “pinhole-free”.

While the resistance layer 15 thus has gaps 49 in the region of the recesses 38 of the carrier 15, the barrier layer 23 also covers the recesses 38 of the carrier 13, the overshadowed sections 79, and the resistance layer 15 present in the environment of the gap 49 continuously with the uniform thickness D (cf. FIGS. 4A, 4B, and 4D). Edges 77 of the gap 49 are thus in particular also covered in a conform manner by the barrier layer 23 such that an influencing of the resistance layer 15 at the edges 77 by moisture may be avoided (cf. FIG. 4D). Furthermore, the carrier 13 again forms respective hollow spaces 31 in the region of the recesses 38, wherein a wall section 35 formed by the respective recess 38 has the gap 49 and is not covered by the resistance layer 15, while an opposite wall section 33 of the carrier 13 that does not form a recess is covered by the resistance layer 15. However, the barrier layer 23 lines the hollow spaces 31 with the constant thickness D in a completely conform manner.

For one embodiment of a thick-film resistance component, FIG. 3C again shows a section of the resistance layer 15 in enlarged form in which the surface structure 21 of the resistance layer 15 forms the hollow space 31 along its surface 19 at the side 25 that faces away from the carrier 13. As can be seen from FIG. 3C, the wall section 35 that forms the recess 37 adopts an angle of >90 degrees with the plane of extent E along which the resistance layer 15 extends. Therefore, a normal N1 of the surface structure 21 intersects the plane of extent E of the resistance layer 15 in the region of the wall section 35 in the direction facing away from the surface 19 of the resistance layer 25. Furthermore, a normal N2 of the surface structure 21 intersects the wall section 35 or the recess 37, which hangs over with respect to the plane of extent E of the resistance layer 15 in this regard, at a lowest point 57 of the hollow space 31 in the direction facing away from the surface 19 of the resistance layer 15. The hollow space 31 is completely covered and lined by the barrier layer 23 such that the surface structure 55 of the barrier layer 23 also has a corresponding hollow space. The same geometric relationships also exist in the case of the recesses 38 of the surface 71 of the carrier 13, illustrated by means of FIGS. 4A, 4B, and 4D, and the hollow spaces 31, wherein the recesses 38 in particular adopt an angle of >90 degrees with a plane of extent of the carrier 13 and said normals may relate to the surface 71 of the carrier 13 in this case.

Furthermore, for the embodiment of a thick-film resistance component, FIG. 2A again shows that the surface structure 21 may have a further hollow space 51 that is, however, filled by the barrier layer 23 and whose opening is therefore closed by the barrier layer 23. Such filled hollow spaces 51 may be produced during the covering of the resistance layer 15 by the barrier layer 23 if respective wall sections 59 of the hollow space 51 have a smaller spacing from one another than twice the thickness D of the barrier layer 23. In this regard, the thickness of the barrier layer 23, measured from a lowest point of such a filled hollow space 51, may possibly approximately correspond to the depth of the hollow space 51 such that the thickness of the barrier layer 23 at such a measurement point may, despite the precise reproduction of the surface structure 21 with a uniform thickness D, differ from this uniform thickness D. However, as explained above, this results merely due to the small spacing of the two wall sections 59 of the hollow space 51 from one another and not due to a non-uniform reproduction of the surface structure 21 of the surface 19 of the resistance layer 15 such that a conform reproduction of the surface structure 21 by the barrier layer 23 ultimately also takes place in the hollow space 51. This may generally also take place in an electrical resistance component 11 configured as a thin-film resistance component.

It can furthermore be seen from FIG. 3A that the barrier layer 23 may comprise a plurality of parallel layers 41 disposed above one another, wherein each layer 41 may have a single atomic layer or an arrangement of a plurality of atomic layers. Accordingly, the layers 41 likewise reproduce the surface structure 21 of the surface 19 of the resistance layer 15 and, due to the parallel arrangement above one another of the layers 41, the thickness D of the barrier layer 23 may ultimately mainly be determined by the number of the layers 41, in particular atomic layers. Such a multilayer design of the barrier layer 23 may also be provided in the resistance component 11 illustrated by means of FIGS. 4A to 4D (thin-film resistance component).

As already explained, the barrier layer 23 comprises an inorganic material and may have an amorphous and/or a semi-crystalline structure. Provision may furthermore be made that the layers 41 comprise different materials and the barrier layer 23 is formed as a laminate of different materials. Provision may furthermore be made that some of the layers 41 form an amorphous structure, while others of the layers 41 form a semi-crystalline structure. The barrier layer 23 may thus comprise a combination of amorphous and semi-crystalline layers 41, wherein the respective structures may in particular be produced by the selection of suitable materials and/or process conditions during a respective cycle of an atomic layer deposition process. In such a laminate of different materials, the individual layers 41 of a respective material may in particular comprise a plurality of atomic layers (e.g. in each case ten atomic layers or more).

In general, such atomic layers 41 may have defects, not shown in FIG. 3A, that may, for example, be produced by a termination of a process step of an atomic layer deposition before a complete formation of a layer 41, wherein a hermetic barrier layer 23 may ultimately be formed by the superposed layers 41. However, due to such defects, the thickness D of the barrier layer 23 may also vary slightly, wherein a ratio between a minimum thickness and a maximum thickness of the barrier layer 23 may, however, be greater than 0.8 and in particular greater than 0.9. The thickness D of the barrier layer 23 may in particular be less than 500 nm and/or amount to at least 100 nm, wherein a thickness D of the barrier layer 23 of 100 nm may already enable a hermetic sealing of the resistance layer 15, while in particular the resistance of the barrier layer 23, and thus its reliability for shielding the resistance layer 15 against moisture, may be increased by increasing the thickness D to up to 500 nm.

Furthermore, it can be seen from FIGS. 2A to 4D that the roughness of the surface structure 55 of the barrier layer 23 may be in a range of 0.2 times to 1.0 times the roughness of the surface structure 21 of the resistance layer 15 and that the roughness of the surface structure 55 of the barrier layer 23 may be less than the roughness of the surface structure 21 of the resistance layer 15 since the barrier layer 23 effects a certain homogenization. FIG. 3B again illustrates that the surface structure 21 of the resistance layer 15 is ultimately determined by its roughness and, compared to the trimming structure 47 in a resistance component 11 configured as a thick-film resistance component, forms a microscopic structure along the surface 19 of the resistance layer 15 that is separated into two sections 61 and 62 by the incision shown of the trimming structure 47. Accordingly, the trimming structure 47 does not form the surface structure 21 of the resistance layer 15, but rather represents a superposition of this surface structure 21.

In the case of a thin-film resistance component, the thickness of the resistance layer 15 may, in contrast, as FIG. 4C illustrates, be less than a roughness of the surface structure 21 of the resistance layer 15 such that the trimming structure 47 may only form a minor incision compared to the roughness of the surface structure 21.

After the barrier layer 23 has been applied and the resistance layer 15 has been covered with a uniform thickness D, a protective layer 43 may be applied to the barrier layer 23 in a step 109 (cf. FIG. 1D). This protective layer may in particular comprise an organic material and may be applied to the barrier layer 23 in a structured manner by means of screen printing. However, the protective layer 43 does not necessarily have to completely reproduce the surface structure 55 of the barrier layer 23; rather, hollow spaces may possibly be produced between the barrier layer 23 and the protective layer 43 in regions of depressions or hollow spaces of the surface structure 55 of the barrier layer 23. However, as FIGS. 2B and 4B illustrate, such hollow spaces may largely be avoided by a careful application of the protective layer 43.

Since the protective layer 43 may comprise an organic material, the protection of the resistance layer 15 with respect to environmental influences may be perfected. The protective layer 43 may in particular reliably enable a passage of moisture in liquid form, for instance of dew, while the barrier layer 23 may seal the resistance layer 15 against moisture in vapor form that may under certain circumstances pass through the organic protective layer 43. Any damage to the resistance layer 15 and/or a change of its electrical properties, for example of a resistance value, due to corrosion may thus be reliably prevented. However, the protective layer 43 may also comprise an inorganic material and combinations of organic and inorganic materials are likewise possible.

For example, the protective layer 43 may comprise, as an organic material, an epoxy resin, a polyimide, a polyamide, a polyimide-amide, a silicone resin, an acrylate, and/or a polyurethane. The protective layer 43 may furthermore comprise silicon dioxide (SiO₂), for example.

In addition to the increased protective effect of the resistance layer 15, the protective layer 43 may, due to its structuring, further be deployed to be used as an etching mask 45 in a step 109 to remove the barrier layer 23 wet chemically in a respective region 65 of the connectors 17 (cf. FIG. 1F). The barrier layer 23, which is in particular applied by atomic layer deposition, may thus be removed from the connectors 17 in a simple manner and in particular without the need for additional and complicated structuring steps in order to enable an electrical connection of the electrical resistance component 11 to further electrical components. Thus, the electrical resistance component 11 shown may also be easily and inexpensively configured as a thin component 11, wherein, however, a high stability over a long time period may simultaneously be ensured due to the reliable protection of the resistance layer with respect to environmental influences.

While the steps for manufacturing the electrical resistance component 11 in FIGS. 1A and 1F are shown for a single electrical resistance component, provision may in particular also be made that the steps explained with reference to FIGS. 1A to 1F take place at a wafer level, wherein the respective electrical resistance components 11 may be separated by a subsequent sawing up of the wafer.

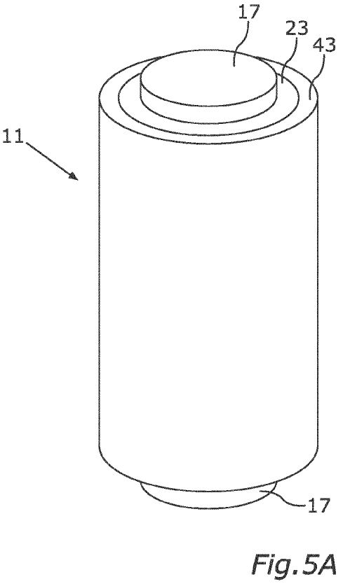

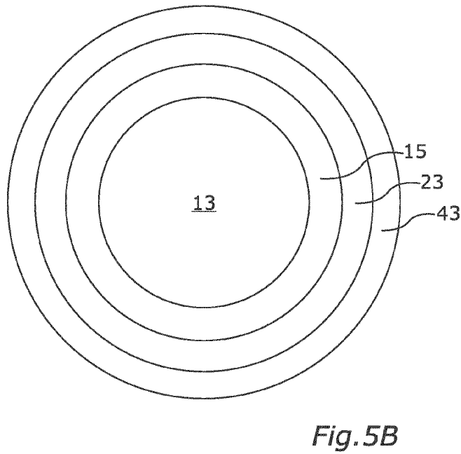

The electrical resistance component 11 schematically shown in cross-section in FIG. 1F may in particular be parallelepiped-shaped such that the resistance layer 15 may be applied in a planar manner to a surface of the carrier 13. In contrast, FIGS. 5A and 5B show a further embodiment in which the carrier 13 is configured as a cylinder and the resistance layer 15 is accordingly configured as a hollow cylinder, wherein the resistance layer 15 peripherally surrounds the carrier 13 (cf. FIG. 5B). Similarly, the protective layer 43 may also surround the barrier layer 23 in a hollow cylindrical shape in such embodiments. As FIG. 5A shows, the connectors 17 of such a cylindrical electrical resistance component 11 may in particular be configured as caps at the carrier 13, wherein the resistance layer 15 may be completely outwardly hermetically sealed by the barrier layer 23 and the protective layer 43.

As an alternative to the embodiment of FIG. 5A, in which the carrier 13 and the connectors 17 have a reduced radius with respect to the barrier layer 23 and the protective layer 43, provision may also be made that the connectors 17 are formed with the same radius as the protective layer 43 and completely cover the end faces of a cylindrical electrical resistance component 11. In this respect, provision may also be made that the connectors are only formed after the application of the resistance layer 15, of the barrier layer 23, and/or of the protective layer 43, wherein, in such embodiments, the barrier layer 23 may in particular not cover the resistance layer 15 in the direction of the end faces of the cylinder in order to enable a contact between the connectors 17 and the resistance layer 15.

### REFERENCE NUMERAL LIST

11 electrical resistance component
13 carrier
15 resistance layer
17 electrical connector
19 surface of the resistance layer
21 surface structure
23 barrier layer
25 side of the resistance layer facing away from the carrier
27 side of the barrier layer facing the resistance layer
29 side of the barrier layer facing away from the resistance layer
31 open hollow space
33 wall section
35 wall section
37 recess
39 opening
41 atomic layer
43 protective layer
45 etching mask
47 trimming structure
49 gap
51 filled hollow space
53 depression
55 surface structure of the barrier layer
57 lowest point
59 wall section of the filled hollow space
61 section of the resistance layer
63 section of the resistance layer
65 region of the barrier layer
67 section of the surface of the resistance layer
69 section of the surface of the barrier layer
71 surface of the carrier
77 edge
101 providing a carrier
103 attaching a connector
105 applying a resistance layer
107 covering the resistance layer with a barrier layer
109 applying a protective layer
111 wet chemical removal of the barrier layer
B1 width
B2 width
D thickness of the barrier layer
E plane of extent
N1 normal of the surface of the resistance layer
N2 normal of the surface of the resistance layer
S direction

1. An electrical resistance component,
comprising an electrically insulating carrier;
at least one resistance layer on the carrier; and
at least one electrical connector formed at the carrier and connected to the resistance layer,
wherein the resistance layer has a surface structure along its surface at a side facing away from the carrier, and
wherein the resistance layer is covered by a barrier layer,
wherein the barrier layer comprises an inorganic material, and
wherein the barrier layer reproduces the surface structure of the resistance layer continuously and with a uniform thickness.

2. An electrical resistance component in accordance with claim 1,
wherein a ratio between a minimum thickness and a maximum thickness of the barrier layer is greater than 0.8.

3. An electrical resistance component in accordance with claim 1,
wherein the thickness of the barrier layer is less than at least one of a roughness of a surface of the carrier or a roughness of the surface structure of the resistance layer.

4. An electrical resistance component in accordance with claim 1,
wherein a roughness of a surface structure of the barrier layer at its side facing away from the resistance layer is less than a roughness of the surface structure of the resistance layer.

5. An electrical resistance component in accordance with claim 1,
wherein the surface structure of the resistance layer forms at least one of:
recesses, wherein the barrier layer covers the recesses continuously and with a uniform thickness; or
open hollow spaces having wall sections, wherein the wall sections of a respective hollow space are disposed opposite one another with respect to the respective hollow space, wherein the barrier layer covers the wall sections of the respective hollow space.

6. An electrical resistance component in accordance with claim 1,
wherein a surface of the carrier facing the resistance layer forms at least one recess, wherein the resistance layer has a gap in the region of the recess, and wherein the barrier layer covers the recess of the carrier and the resistance layer present in the environment of the gap continuously and with a uniform thickness.

7. An electrical resistance component in accordance with claim 1,
wherein the barrier layer has at least one of a thickness of at most 1000 nanometers or a thickness of at least 5 nanometers.

8. (canceled)

9. (canceled)

10. An electrical resistance component in accordance with claim 1,
wherein the barrier layer has at least one of:
at least one layer having an amorphous structure or
at least one layer having a semi-crystalline structure.

11. An electrical resistance component in accordance claim 1,
wherein the barrier layer comprises at least a first layer formed from a first material and at least a second layer formed from a second material, wherein the first material and the second material differ from one another.

12. (canceled)

13. (canceled)

14. An electrical resistance component in accordance with claim 1,
wherein the barrier layer includes an atomic layer deposited onto the resistance layer.

15. (canceled)

16. An electrical resistance component in accordance with claim 1,
wherein the barrier layer is at least partly covered by a protective layer.

17. (canceled)

18. (canceled)

19. (canceled)

20. (canceled)

21. (canceled)

22. (canceled)

23. A method of manufacturing an electrical resistance component,
comprising the steps:
providing an electrically insulating carrier;
attaching at least one electrical connector to the carrier;
applying at least one resistance layer to the carrier, wherein the resistance layer has a surface structure along its surface at a side facing away from the carrier; and
covering the resistance layer with a barrier layer that comprises an inorganic material and that reproduces the surface structure of the resistance layer continuously and with a uniform thickness.

24. A method in accordance with claim 23,
wherein the barrier layer is applied to the resistance layer by atomic layer deposition.

25. A method in accordance with claim 24,
wherein the resistance layer is covered by a plurality of layers that jointly form the barrier layer.

26. A method in accordance with claim 25,
wherein a first layer of the plurality of layers is formed from a first material and a second layer of the plurality of layers is formed from a second material, wherein the first material and the second material differ from one another.

27. A method in accordance with claim 25,
wherein at least one layer of the plurality of layers has an amorphous structure, and wherein at least one layer of the plurality of layers has a semi-crystalline structure.

28. (canceled)

29. A method in accordance with claim 23,
wherein a protective layer is applied to the barrier layer.

30. (canceled)

31. A method in accordance with claim 29,
wherein the protective layer is applied to the barrier layer in a structured manner by means of screen printing.

32. A method in accordance with claim 29,
wherein the barrier layer is removed wet chemically in the region of the connector, wherein the protective layer is used as an etching mask.

33. An electrical resistance component,
comprising an electrically insulating carrier;
at least one resistance layer on the carrier; and
at least one electrical connector formed at the carrier and connected to the resistance layer,
wherein the resistance layer has a surface structure along its surface at a side facing away from the carrier, and
wherein the resistance layer is covered by a barrier layer,
wherein the barrier layer comprises an inorganic material, and
wherein the barrier layer reproduces the surface structure of the resistance layer continuously and with a uniform thickness,
wherein the barrier layer comprises a plurality of atomic layers that extend in parallel above one another and that reproduce the surface structure of the resistance layer.
